(19) United States
(12) Patent Application Publication
(10) Pub. No.: US 2019/0095758 A1
(43) Pub. Date: Mar. 28, 2019

(54) METHOD AND SYSTEM FOR OBTAINING PICTURE ANNOTATION DATA

(71) Applicant: BAIDU ONLINE NETWORK TECHNOLOGY (BEIJING) CO., LTD, Haidian District Beijing (CN)

(72) Inventors: Guoyi LIU, Haidian District Beijing (CN); Guang LI, Haidian District Beijing (CN); Shumin HAN, Haidian District Beijing (CN)

(73) Assignee: BAIDU ONLINE NETWORK TECHNOLOGY (BEIJING) CO., LTD ., Haidian District Beijing (CN)

(21) Appl. No.: 16/118,026

(22) Filed: Aug. 30, 2018

(30) Foreign Application Priority Data
Sep. 27, 2017 (CN) 2017108897678

(51) Int. Cl. G06K 9/62

(52) U.S. Cl. CPC G06K 9/6256; G06F 3/04817; G06K 9/6254

(57) ABSTRACT

The present disclosure provides a method and system for obtaining picture annotation data. The method comprises: obtaining a recognition result of a to-be-annotated picture; displaying the to-be-annotated picture and a corresponding recognition result on an annotation interface; using an annotator's selection of the recognition result in the annotation interface, to obtain annotation data of the to-be-annotated picture. According to the method and system for obtaining picture annotation data of the present disclosure, the annotator only needs to perform an operation of clicking the corresponding recognition result without manually inputting the name, and improves the annotation efficiency. The technical solution is particularly adapted for beforehand data preparation work of an image vertical type recognition algorithm, may substantially reduce costs of manually annotating pictures, and shorten the development cycle of picture recognition-type projects.

The present application claims the priority of Chinese Patent Application No. 201710889767.8, filed on Sep. 27, 2017, with the title of “Method and system for obtaining picture annotation data”. The disclosure of the above applications is incorporated herein by reference in its entirety.

### FIELD OF THE DISCLOSURE

The present disclosure relates to the field of computer processing technologies, and particularly to a method and system for obtaining picture annotation data.

### BACKGROUND OF THE DISCLOSURE

In massive information produced and stored by the Internet, pictures are a kind of important information carriers. In the Internet information provision and information search service, processing picture information appears more and more important.

Picture annotation is a very important task for preparing training data in the field of computer vision. Usually, a lot of manually-annotated pictures are needed as an initial training data set for further data processing and data mining of machine learning and computer vision.

However, picture annotation is a boring, simple and repeated job. Particularly, when the picture content is annotated manually, an annotator needs to observe pictures and manually input picture-describing words. Therefore, the annotation efficiency is low, and the manpower costs are high.

### SUMMARY OF THE DISCLOSURE

A plurality of aspects of the present disclosure provide a method and system for obtaining picture annotation data, to reduce costs of obtaining picture annotation data.

According to an aspect of the present disclosure, there is provided a method of obtaining picture annotation data, comprising:

obtaining a recognition result of a to-be-annotated picture;

displaying the to-be-annotated picture and the corresponding recognition result on an annotation interface;

using an annotator's selection of the recognition result in the annotation interface, to obtain annotation data of the to-be-annotated picture.

The above aspect and any possible implementation mode further provide an implementation mode: the obtaining a recognition result of a to-be-annotated picture comprises: obtaining the recognition result of the to-be-annotated picture through machine learning.

The above aspect and any possible implementation mode further provide an implementation mode: the recognition result comprises: identification information and confidence parameters of one or more target objects corresponding to the to-be-annotated picture.

The above aspect and any possible implementation mode further provide an implementation mode: the displaying the to-be-annotated picture and a corresponding recognition result on an annotation interface comprises:

providing an information selection area, sequentially displaying the identification information of said one or more target objects in the information selection area according to magnitude of the confidence parameters, for selection by the annotator.

The above aspect and any possible implementation mode further provide an implementation mode: the displaying the to-be-annotated picture and a corresponding recognition result on an annotation interface further comprises:

while displaying the identification information of the target object, displaying one or more sample pictures corresponding to the target object for comparison and reference of the annotator with the to-be-annotated picture, wherein the sample picture is a picture obtained from a picture repository and matched with a search keyword, with the identification information of the target object as the search keyword.

The above aspect and any possible implementation mode further provide an implementation mode: the annotation interface further displays an information input area;

the method further comprises:

if the annotator does not select the recognition result in the annotation interface, regarding information input by the annotator in the information input area as the annotation data of the to-be-annotated picture.

The above aspect and any possible implementation mode further provide an implementation mode: the displaying the to-be-annotated picture and a corresponding recognition result on an annotation interface further comprises:

providing a button of replacing the to-be-annotated picture in the annotation interface,

upon clicking the button, replacing in the annotation interface with next to-be-annotated picture and corresponding recognition result.

The above aspect and any possible implementation mode further provide an implementation mode: the method further comprises: regarding the to-be-annotated picture and the annotation data as sample data to train a recognition model of machine learning.

According to another aspect of the present disclosure, there is provided a system of obtaining picture annotation data, comprising:

a recognition unit configured to obtain a recognition result of a to-be-annotated picture;

a displaying unit configured to display the to-be-annotated picture and the corresponding recognition result on an annotation interface;

an annotation recognition unit configured to use an annotator's selection of the recognition result in the annotation interface, to obtain annotation data of the to-be-annotated picture.

The above aspect and any possible implementation mode further provide an implementation mode: the recognition unit is specifically configured to obtain the recognition result and a confidence parameter of the to-be-annotated picture through machine learning.

The above aspect and any possible implementation mode further provide an implementation mode: the recognition result comprises: identification information of one or more target objects corresponding to the to-be-annotated picture.

The above aspect and any possible implementation mode further provide an implementation mode: the displaying unit is specifically configured to:

provide an information selection area, and sequentially display the identification information of said one or more target objects in the information selection area according to magnitude of the confidence parameters, for selection by the annotator.

The above aspect and any possible implementation mode further provide an implementation mode: the displaying unit is further configured to:

while displaying the identification information of the target object, display one or more sample pictures corresponding to the target object for comparison and reference of the annotator with the to-be-annotated picture, wherein the sample picture is a picture obtained from a picture repository and matched with a search keyword, with the identification information of the target object as the search keyword.

The above aspect and any possible implementation mode further provide an implementation mode: the annotation interface further displays an information input area; the annotation recognition unit is further configured to, if the annotator does not select the recognition result in the annotation interface, regard information input by the annotator in the information input area as the annotation data of the to-be-annotated picture.

The above aspect and any possible implementation mode further provide an implementation mode: the displaying unit is further configured to:

provide a button of replacing the to-be-annotated picture in the annotation interface,

upon clicking the button, replacing in the annotation interface with next to-be-annotated picture and corresponding recognition result.

The above aspect and any possible implementation mode further provide an implementation mode: the system further comprises a training unit configured to regard the to-be-annotated picture and the annotation data as sample data to train a recognition model of machine learning.

According to a further aspect of the present disclosure, the present disclosure provides a device, comprising:

one or more processors,

a storage for storing one or more programs,

the one or more programs, when executed by said one or more processors, enable said one or more processors to implement any of the abovementioned methods.

According to a further aspect of the present disclosure, the present disclosure provides a computer readable medium on which a computer program is stored, wherein the program, when executed by a processor, implements any of the abovementioned methods.

As known from the above technical solutions, in embodiments of the present disclosure, it is feasible to obtain the recognition result of the to-be-annotated picture; display the to-be-annotated picture and the recognition result on the annotation interface; use the annotator's selection of the recognition result in the annotation interface, to obtain the annotation data of the to-be-annotated picture. The annotator only needs to perform an operation of clicking the corresponding recognition result without manually inputting the name, and improves the annotation efficiency.

### BRIEF DESCRIPTION OF DRAWINGS

To describe technical solutions of embodiments of the present disclosure more clearly, figures to be used in the embodiments or in depictions regarding the prior art will be described briefly. Obviously, the figures described below are only some embodiments of the present disclosure. Those having ordinary skill in the art appreciate that other figures may be obtained from these figures without making inventive efforts.

FIG. 1 is a flow chart of a method of obtaining picture annotation data according to an embodiment of the present disclosure;

FIG. 2 is a diagram of an instance of an information selection area according to an embodiment of the present disclosure;

FIG. 3 is a structural schematic diagram of a system of obtaining picture annotation data according to another embodiment of the present disclosure;

FIG. 4 is a block diagram of an example computer system/server adapted to implement an implementation mode of the present disclosure.

### DETAILED DESCRIPTION OF PREFERRED EMBODIMENTS

To make objectives, technical solutions and advantages of embodiments of the present disclosure clearer, technical solutions of embodiment of the present disclosure will be described clearly and completely with reference to figures in embodiments of the present disclosure. Obviously, embodiments described here are partial embodiments of the present disclosure, not all embodiments. All other embodiments obtained by those having ordinary skill in the art based on the embodiments of the present disclosure, without making any inventive efforts, fall within the protection scope of the present disclosure.

In addition, the term “and/or” used in the text is only an association relationship depicting associated objects and represents that three relations might exist, for example, A and/or B may represents three cases, namely, A exists individually, both A and B coexist, and B exists individually. In addition, the symbol “/” in the text generally indicates associated objects before and after the symbol are in an “or” relationship.

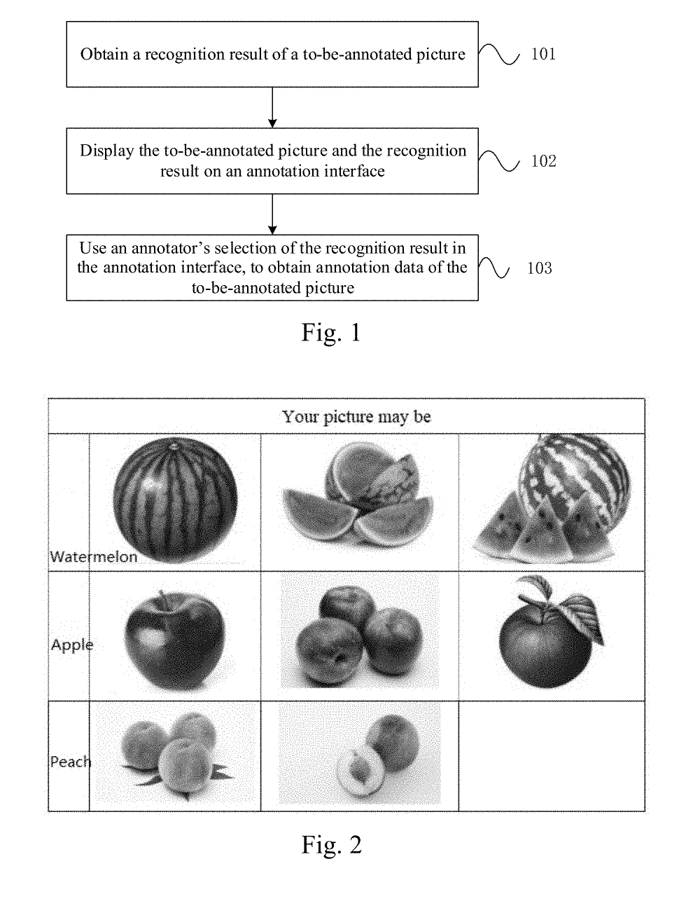

FIG. 1 is a flow chart of a method of obtaining picture annotation data according to an embodiment of the present disclosure. As shown in FIG. 1, the method comprises the following steps:

Step 101: obtaining a recognition result of a to-be-annotated picture;

Preferably, a server obtains the to-be-annotated picture, recognizes the to-be-annotated picture through machine learning to obtain identification information and a confidence parameter of a target object corresponding to the to-be-annotated picture.

In the present embodiment, the confidence parameter may be used to characterize a probability that the to-be-annotated picture is the target object, namely, a similarity between the to-be-annotated picture and sample data of the target object, when the to-be-annotated picture is recognized. If a value of the confidence parameter is higher, the probability that the to-be-annotated picture is the target object is larger.

In the present embodiment, commonly-used models of machine learning may include but not limited to: Auto Encoder, Sparse Coding, Deep Belief Networks, and Convolutional Neural Networks. The machine learning manner may also be called deep learning.

In the present embodiment, it is feasible to first build a recognition model corresponding to a machine learning recognition manner used for recognizing the to-be-annotated picture, and then use the recognition model to recognize the to-be-annotated picture. A principle of using the recognition model corresponding to the machine learning manner to recognize the to-be-annotated picture is summarized as follows: when the recognition model (e.g., a convolutional neural network model) is used to recognize the to-be-annotated picture, it is possible to represent a to-be-recognized object in the to-be-annotated picture with some features (e.g., Scale Invariant Feature Transform feature points), and generate an input vector. After the to-be-recognized picture is recognized with the recognition model, it is possible to obtain an output vector characterizing the target object corresponding to the to-be-annotated picture. The recognition model may be used to indicate a mapping relationship of the input vector to the output vector, and then recognize the to-be-annotated picture based on the mapping relationship.

In the present embodiment, when the to-be-annotated picture is recognized with the recognition model, it is possible to use some features (e.g., Scale Invariant Feature Transform feature points) to characterize the to-be-recognized object in the to-be-annotated picture, and possible to match features of the to-be-recognized object (e.g., apple object) in the to-be-annotated picture with the target object (e.g., sample data of the apple object), to obtain the confidence parameter that the to-be-annotated picture is the target object.

Preferably, the recognition model obtains the identification information and confidence parameters of one or more target objects corresponding to the to-be-annotated picture.

For example, the content of the to-be-annotated picture is apple, the target objects obtained by the recognition model and corresponding to the to-be-annotated picture are watermelon, apple and peach, and their confidence parameters reduce in turn.

In the present embodiment, it is possible to, according to a type of the to-be-annotated picture, preset sample data corresponding to the type of the to-be-annotated picture, and then use the sample data to train the recognition model. For example, it is feasible to pre-obtain pictures of some common application scenarios and annotation information of the pictures as training data.

Step 102: displaying the to-be-annotated picture and the recognition result on an annotation interface;

Preferably, the server pushes an annotation page to the annotator; displays the to-be-annotated picture and the identification information of one or more target objects obtained from the recognition model and corresponding to the to-be-annotated picture on the annotation interface.

Preferably, it is feasible to, while displaying the to-be-annotated picture to the annotator, provide an information selection area which is used to sequentially display the identification information of said one or more target objects according to the magnitude of the confidence parameters, for selection by the annotator, and regard a result selected by the annotator as annotation data. The identification information of said one or more target objects may be in a button form which will be clicked by the annotator. It is possible to disorderly display the identification information of said one or more target objects, to avoid the annotator's cheat of only clicking the identification information of the first target object of the sequentially-displayed target objects.

Preferably, target objects whose confidence parameters are higher than a confidence threshold are selected from one or more target objects obtained by the recognition model and corresponding to the to-be-annotated picture, and are displayed.

Preferably, if the number of target objects whose confidence parameters are higher than the confidence threshold is larger than or equal to a preset number, the preset number of target objects are selected, and obviously impossible target objects are removed; if the number of target objects whose confidence parameters are higher than the confidence threshold is smaller than the preset number, target objects whose confidence parameters are higher than the confidence threshold are selected, wherein the preset number may be set as 3. It is possible, through the above steps, reduce the number of recognition results displayed to the annotator, remove recognition results with an obviously lower probability, and improve the annotator's selection efficiency.

Preferably, while the identification information of the target object is displayed in the information selection area, one or more sample pictures, e.g., three sample pictures, corresponding to the target object may be displayed for comparison and reference of the annotator with the to-be-annotated picture. The sample picture may be a picture obtained from a picture repository and matched with a search keyword, with the identification information of the target object as the search keyword; the sample picture may also be a picture obtained from an encyclopedia type webpage and matched with a search keyword, with the identification information of the target object as the search keyword. For example, the information selection area provides three sample pictures of watermelon after the watermelon identification information; provides three sample pictures of apples after the apple identification information; provides two sample pictures of peaches after the peach identification information; the annotator may compare the to-be-annotated picture with the sample pictures to further determine the content of the to-be-annotated picture.

Preferably, in the annotation interface, a button of replacing the to-be-annotated picture may be provided. When the annotator judges that the content of the to-be-annotated picture does not belong to any recognition result in the information selection area, including a case in which the annotator cannot determine that the content of the to-be-annotated picture might be the first recognition result or the second recognition result, for example, the annotator believes that the to-be-annotated picture is not any one of watermelon, apple and peach; or believes that the to-be-annotated picture might be watermelon or apple, but cannot be determined, the annotator may skip annotation of this to-be-annotated picture, click the button of replacing the to-be-annotated picture, to replace this to-be-annotated picture with next to-be-annotated picture. In this case, it is believed that the annotator's annotation result is failure to judge.

Preferably, an information input area may be provided in the annotation interface. When the annotator judges that the content of the to-be-annotated picture does not belong to any recognition result in the information selection area, he may not select the recognition result, and may auxiliarily input his judgment result in the information input area, and the judgment result input by the annotator may be regarded as the annotation data.

Preferably, in the annotation interface, after the annotator selects the identification information of the target object or inputs his judgment result, the annotation interface automatically replaces with next to-be-annotated picture. The annotator may also click the button of replacing the to-be-annotated picture to replace with next to-be-annotated picture.

Step 103: using the annotator's selection of the recognition result in the annotation interface, to obtain the annotation data of the to-be-annotated picture.

Preferably, it is feasible to, according to the recognition result selected by the annotator for the to-be-annotated picture and/or the judgment result input by the annotator, obtain the annotation data of the to-be-annotated picture, and store the to-be-annotated picture and the annotation data in parallel.

Preferably, it is feasible to display the same to-be-annotated picture on annotation interfaces of a plurality of annotators; record recognition results selected by the plurality of annotators for the to-be-annotated picture and/or judgment results input by the plurality of annotators; if more than a preset proportion of annotators select the same recognition result and/or input judgment result, determine the result as the annotation data of the to-be-annotated picture, and store the to-be-annotated picture and the annotation data in parallel. For example, the to-be-annotated picture whose content is apple shown in FIG. 2 is displayed to 100 annotators in the annotation interface. If more than 90% annotators all select “apple”, “apple” may be considered as the annotation data of the to-be-annotated picture. It may be appreciated that the above proportion may be flexibly set according to actual accuracy demands.

Preferably, it is feasible to display the annotation result as failure to judge, namely, the annotator's skip of the to-be-annotated picture which he is attempting to annotate, on annotation interfaces of a plurality of annotators; record recognition results selected by the plurality of annotators for the to-be-annotated picture and/or judgment results input by the plurality of annotators; if more than a preset proportion of annotators select the same recognition result and/or input judgment result, determine the result as the annotation data of the to-be-annotated picture, and store the to-be-annotated picture and the annotation data in parallel. The recognition accuracy is further improved.

In the present embodiment, the to-be-annotated picture and the annotation data may be regarded as sample data to train the recognition model of machine learning. Take a convolutional neural network as the recognition model as an example. It is feasible to regard the features (e.g., Scale Invariant Feature Transform feature points) of the to-be-annotated picture as an input vector of the convolutional neural network, regard the annotation data as an ideal output vector of the convolutional neural network, use a vector pair comprised of the input vector and output vector to train the convolutional neural network so as to use a correct recognition result, namely, the annotation data obtained by manually annotating the to-be-recognized picture by this method, to train the recognition model, thereby improving the training effect of the recognition model, and thereby enhancing the recognition accuracy in subsequent recognition of the to-be-annotated picture.

As known from the technical solution, it is feasible to obtain a recognition result of a to-be-annotated picture; display the to-be-annotated picture and the recognition result on the annotation interface; use the annotator's selection of the recognition result in the annotation interface, to obtain the annotation data of the to-be-annotated picture. The annotator only needs to perform an operation of clicking the corresponding recognition result without manually inputting the name, and improves the annotation efficiency. The technical solution is particularly adapted for beforehand data preparation work of an image vertical type recognition algorithm, may substantially reduce costs of manually annotating pictures, and shorten the development cycle of picture recognition-type projects.

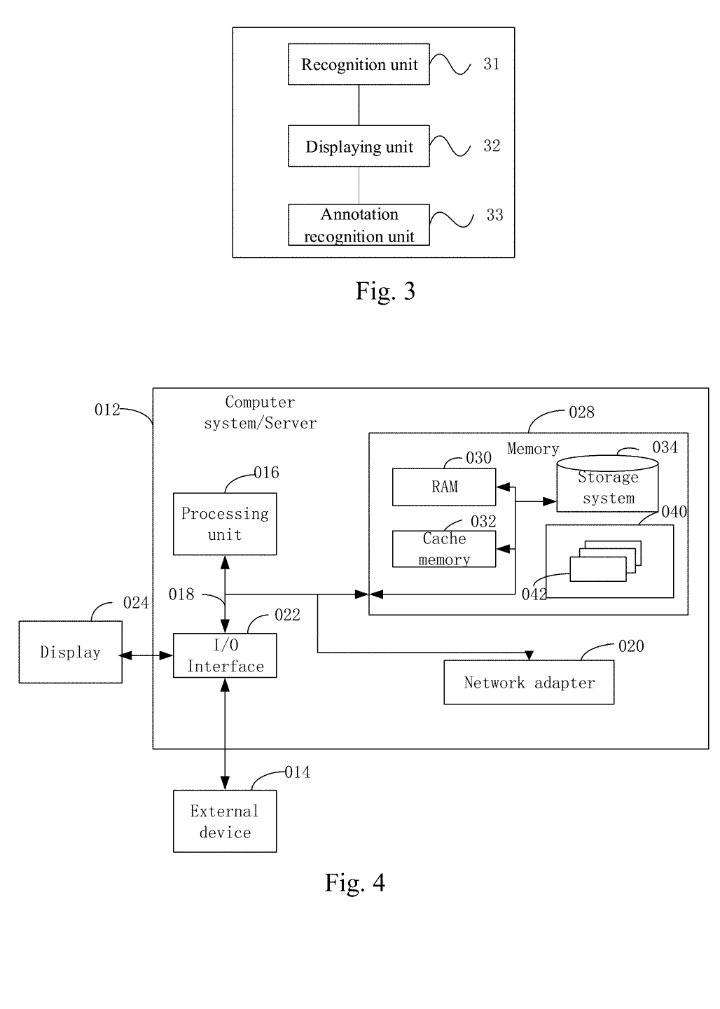

FIG. 3 is a structural schematic diagram of a system of obtaining picture annotation data according to another embodiment of the present disclosure. As shown in FIG. 3, the apparatus comprises:

a recognition unit 31 configured to obtain a recognition result of a to-be-annotated picture;

Preferably, the recognition unit 31 obtains the to-be-annotated picture, recognizes the to-be-annotated picture through machine learning to obtain identification information and a confidence parameter of a target object corresponding to the to-be-annotated picture.

In the present embodiment, the confidence parameter may be used to characterize a probability that the to-be-annotated picture is the target object, namely, a similarity between the to-be-annotated picture and sample data of the target object, when the to-be-annotated picture is recognized. If a value of the confidence parameter is higher, the probability that the to-be-annotated picture is the target object is larger.

In the present embodiment, commonly-used models of machine learning may include but not limited to: Auto Encoder, Sparse Coding, Deep Belief Networks, and Convolutional Neural Networks. The machine learning manner may also be called deep learning.

In the present embodiment, it is feasible to first build a recognition model corresponding to a machine learning recognition manner used for recognizing the to-be-annotated picture, and then use the recognition model to recognize the to-be-annotated picture. A principle of using the recognition model corresponding to the machine learning manner to recognize the to-be-annotated picture is summarized as follows: when the recognition model (e.g., a convolutional neural network model) is used to recognize the to-be-annotated picture, it is possible to represent a to-be-recognized object in the to-be-annotated picture with some features (e.g., Scale Invariant Feature Transform feature points), and generate an input vector. After the to-be-recognized picture is recognized with the recognition model, it is possible to obtain an output vector characterizing the target object corresponding to the to-be-annotated picture. The recognition model may be used to indicate a mapping relationship of the input vector to the output vector, and then recognize the to-be-annotated picture based on the mapping relationship.

In the present embodiment, when the to-be-annotated picture is recognized with the recognition model, it is possible to use some features (e.g., Scale Invariant Feature Transform feature points) to characterize the to-be-recognized object in the to-be-annotated picture, and possible to match features of the to-be-recognized object (e.g., apple object) in the to-be-annotated picture with the target object (e.g., sample data of the apple object), to obtain the confidence parameter that the to-be-annotated picture is the target object.

Preferably, the recognition model obtains the identification information and confidence parameters of one or more target objects corresponding to the to-be-annotated picture.

For example, the content of the to-be-annotated picture is apple, the target objects obtained by the recognition model and corresponding to the to-be-annotated picture are watermelon, apple and peach, and their confidence parameters reduce in turn.

In the present embodiment, it is possible to, according to a type of the to-be-annotated picture, preset sample data corresponding to the type of the to-be-annotated picture, and then use the sample data to train the recognition model. For example, it is feasible to pre-obtain pictures of some common application scenarios and annotation information of the pictures as training data.

A displaying unit 32 configured to display the to-be-annotated picture and the recognition result on an annotation interface;

Preferably, the displaying unit 32 pushes an annotation page to the annotator; displays the to-be-annotated picture and the identification information of one or more target objects obtained from the recognition model and corresponding to the to-be-annotated picture on the annotation interface.

Preferably, it is feasible to, while displaying the to-be-annotated picture to the annotator, provide an information selection area which is used to sequentially display the identification information of said one or more target objects according to the magnitude of the confidence parameters, for selection by the annotator, and regard a result selected by the annotator as annotation data. The identification information of said one or more target objects may be in a button form which will be clicked by the annotator. It is possible to disorderly display the identification information of said one or more target objects, to avoid the annotator's cheat of only clicking the identification information of the first target object of the sequentially-displayed target objects.

Preferably, target objects whose confidence parameters are higher than a confidence threshold are selected from one or more target objects obtained by the recognition model and corresponding to the to-be-annotated picture, and are displayed.

Preferably, if the number of target objects whose confidence parameters are higher than the confidence threshold is larger than or equal to a preset number, the preset number of target objects are selected, and obviously impossible target objects are removed; if the number of target objects whose confidence parameters are higher than the confidence threshold is smaller than the preset number, target objects whose confidence parameters are higher than the confidence threshold are selected, wherein the preset number may be set as 3. It is possible, through the above steps, reduce the number of recognition results displayed to the annotator, remove recognition results with an obviously lower probability, and improve the annotator's selection efficiency.

Preferably, while the identification information of the target object is displayed in the information selection area, one or more sample pictures, e.g., three sample pictures, corresponding to the target object may be displayed for comparison and reference of the annotator with the to-be-annotated picture. The sample picture may be a picture obtained from a picture repository and matched with a search keyword, with the identification information of the target object as the search keyword; the sample picture may also be a picture obtained from an encyclopedia type webpage and matched with a search keyword, with the identification information of the target object as the search keyword. For example, as shown in FIG. 2, the information selection area provides three sample pictures of watermelon after the watermelon identification information; provides three sample pictures of apples after the apple identification information; provides two sample pictures of peaches after the peach identification information; the annotator may compare the to-be-annotated picture with the sample pictures to further determine the content of the to-be-annotated picture.

Preferably, in the annotation interface, a button of replacing the to-be-annotated picture may be provided. When the annotator judges that the content of the to-be-annotated picture does not belong to any recognition result in the information selection area, including a case in which the annotator cannot determine that the content of the to-be-annotated picture might be the first recognition result or the second recognition result, for example, the annotator believes that the to-be-annotated picture is not any one of watermelon, apple and peach; or believes that the to-be-annotated picture might be watermelon or apple, but cannot be determined, the annotator may skip annotation of this to-be-annotated picture, click the button of replacing the to-be-annotated picture, to replace this to-be-annotated picture with next to-be-annotated picture. In this case, it is believed that the annotator's annotation result is failure to judge.

Preferably, an information input area may be provided in the annotation interface. When the annotator judges that the content of the to-be-annotated picture does not belong to any recognition result in the information selection area, he may not select the recognition result, and may auxiliarily input his judgment result in the information input area, and the judgment result input by the annotator may be regarded as the annotation data.

Preferably, in the annotation interface, after the annotator selects the identification information of the target object or inputs his judgment result, the annotation interface automatically replaces with next to-be-annotated picture. The annotator may also click the button of replacing the to-be-annotated picture to replace with next to-be-annotated picture.

An annotation recognition unit 33 configured to use the annotator's selection of the recognition result in the annotation interface, to obtain the annotation data of the to-be-annotated picture.

Preferably, the annotation recognition unit 33, according to the recognition result selected by the annotator for the to-be-annotated picture and/or the judgment result input by the annotator, obtain the annotation data of the to-be-annotated picture, and store the to-be-annotated picture and the annotation data in parallel.

Preferably, it is feasible to display the same to-be-annotated picture on annotation interfaces of a plurality of annotators; record recognition results selected by the plurality of annotators for the to-be-annotated picture and/or judgment results input by the plurality of annotators; if more than a preset proportion of annotators select the same recognition result and/or input judgment result, determine the result as the annotation data of the to-be-annotated picture, and store the to-be-annotated picture and the annotation data in parallel. For example, the to-be-annotated picture whose content is apple shown in FIG. 2 is displayed to 100 annotators in the annotation interface. If more than 90% annotators all select “apple”, “apple” may be considered as the annotation data of the to-be-annotated picture. It may be appreciated that the above proportion may be flexibly set according to actual accuracy demands.

Preferably, it is feasible to display the annotation result of failure to judge, namely, the annotator's skip of the to-be-annotated picture which he is attempting to annotate, on annotation interfaces of a plurality of annotators; record recognition results selected by the plurality of annotators for the to-be-annotated picture and/or judgment results input by the plurality of annotators; if more than a preset proportion of annotators select the same recognition result and/or input judgment result, determine the result as the annotation data of the to-be-annotated picture, and store the to-be-annotated picture and the annotation data in parallel. The recognition accuracy is further improved.

In the present embodiment, the system further comprises a training unit 34 configured to regard the to-be-annotated picture and the annotation data as sample data to train the recognition model of machine learning. Take a convolutional neural network as the recognition model as an example. It is feasible to regard the features (e.g., Scale Invariant Feature Transform feature points) of the to-be-annotated picture as an input vector of the convolutional neural network, regard the annotation data as an ideal output vector of the convolutional neural network, use a vector pair comprised of the input vector and output vector to train the convolutional neural network so as to use a correct recognition result, namely, the annotation data obtained by manually annotating the to-be-recognized picture by this method, to train the recognition model, thereby improving the training effect of the recognition model, and thereby enhancing the recognition accuracy in subsequent recognition of the to-be-annotated picture.

As known from the technical solution, it is feasible to obtain a recognition result of a to-be-annotated picture; display the to-be-annotated picture and the recognition result on the annotation interface; use the annotator's selection of the recognition result in the annotation interface, to obtain the annotation data of the to-be-annotated picture. The annotator only needs to perform an operation of clicking the corresponding recognition result without manually inputting the name, and improves the annotation efficiency. The technical solution is particularly adapted for beforehand data preparation work of an image vertical type recognition algorithm, may substantially reduce costs of manually annotating pictures, and shorten the development cycle of picture recognition-type projects.

It needs to be appreciated that regarding the aforesaid method embodiments, for ease of description, the aforesaid method embodiments are all described as a combination of a series of actions, but those skilled in the art should appreciated that the present disclosure is not limited to the described order of actions because some steps may be performed in other orders or simultaneously according to the present disclosure. Secondly, those skilled in the art should appreciate the embodiments described in the description all belong to preferred embodiments, and the involved actions and modules are not necessarily requisite for the present disclosure.

In the above embodiments, different emphasis is placed on respective embodiments, and reference may be made to related depictions in other embodiments for portions not detailed in a certain embodiment.

Those skilled in the art can clearly understand that for purpose of convenience and brevity of depictions, reference may be made to corresponding procedures in the aforesaid method embodiments for specific operation procedures of the system, apparatus and units described above, which will not be detailed any more.

In the embodiments provided by the present disclosure, it should be understood that the revealed method and apparatus can be implemented in other ways. For example, the above-described embodiments for the apparatus are only exemplary, e.g., the division of the units is merely logical one, and, in reality, they can be divided in other ways upon implementation. For example, a plurality of units or components may be combined or integrated into another system, or some features may be neglected or not executed. In addition, mutual coupling or direct coupling or communicative connection as displayed or discussed may be indirect coupling or communicative connection performed via some interfaces, means or units and may be electrical, mechanical or in other forms.

The units described as separate parts may be or may not be physically separated, the parts shown as units may be or may not be physical units, i.e., they can be located in one place, or distributed in a plurality of network units. One can select some or all the units to achieve the purpose of the embodiment according to the actual needs.

Further, in the embodiments of the present disclosure, functional units can be integrated in one processing unit, or they can be separate physical presences; or two or more units can be integrated in one unit. The integrated unit described above can be implemented in the form of hardware, or they can be implemented with hardware plus software functional units.

FIG. 4 illustrates a block diagram of an example computer system/server 012 adapted to implement an implementation mode of the present disclosure. The computer system/server 012 shown in FIG. 4 is only an example and should not bring about any limitation to the function and scope of use of the embodiments of the present disclosure.

As shown in FIG. 4, the computer system/server 012 is shown in the form of a general-purpose computing device. The components of computer system/server 012 may include, but are not limited to, one or more processors (processing units) 016, a memory 028, and a bus 018 that couples various system components including system memory 028 and the processor 016.

Bus 018 represents one or more of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus.

Computer system/server 012 typically includes a variety of computer system readable media. Such media may be any available media that is accessible by computer system/server 012, and it includes both volatile and non-volatile media, removable and non-removable media.

Memory 028 can include computer system readable media in the form of volatile memory, such as random access memory (RAM) 030 and/or cache memory 032. Computer system/server 012 may further include other removable/non-removable, volatile/non-volatile computer system storage media. By way of example only, storage system 034 can be provided for reading from and writing to a non-removable, non-volatile magnetic media (not shown in FIG. 4 and typically called a “hard drive”). Although not shown in FIG. 4, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each drive can be connected to bus 018 by one or more data media interfaces. The memory 028 may include at least one program product having a set (e.g., at least one) of program modules that are configured to carry out the functions of embodiments of the present disclosure.

Program/utility 040, having a set (at least one) of program modules 042, may be stored in the system memory 028 by way of example, and not limitation, as well as an operating system, one or more disclosure programs, other program modules, and program data. Each of these examples or a certain combination thereof might include an implementation of a networking environment. Program modules 042 generally carry out the functions and/or methodologies of embodiments of the present disclosure.

Computer system/server 012 may also communicate with one or more external devices 014 such as a keyboard, a pointing device, a display 024, etc. In the present disclosure, the computer system/server 012 communicates with an external radar device, or with one or more devices that enable a user to interact with computer system/server 012; and/or with any devices (e.g., network card, modem, etc.) that enable computer system/server 012 to communicate with one or more other computing devices. Such communication can occur via Input/Output (I/O) interfaces 022. Still yet, computer system/server 012 can communicate with one or more networks such as a local area network (LAN), a general wide area network (WAN), and/or a public network (e.g., the Internet) via a network adapter 020. As depicted in the figure, network adapter 020 communicates with the other communication modules of computer system/server 012 via the bus 018. It should be understood that although not shown, other hardware and/or software modules could be used in conjunction with computer system/server 012. Examples, include, but are not limited to: microcode, device drivers, redundant processing units, external disk drive arrays, RAID systems, tape drives, and data archival storage systems, etc.

The processing unit 016 executes functions and/or methods in embodiments described in the present disclosure by running programs stored in the memory 028.

The above-mentioned computer program may be set in a computer storage medium, i.e., the computer storage medium is encoded with a computer program. When the program, executed by one or more computers, enables said one or more computers to execute steps of methods and/or operations of apparatuses as shown in the above embodiments of the present disclosure.

As time goes by and technologies develop, the meaning of medium is increasingly broad. A propagation channel of the computer program is no longer limited to tangible medium, and it may also be directly downloaded from the network. The computer-readable medium of the present embodiment may employ any combinations of one or more computer-readable media. The machine readable medium may be a computer readable signal medium or a computer readable storage medium. A computer readable medium for example may include, but not limited to, an electronic, magnetic, optical, electromagnetic, infrared, or semiconductor system, apparatus, or device, or any suitable combination of the foregoing. More specific examples (non-exhaustive listing) of the computer readable storage medium would include an electrical connection having one or more conductor wires, a portable computer magnetic disk, a hard disk, a random access memory (RAM), a read-only memory (ROM), an erasable programmable read-only memory (EPROM or Flash memory), optical fiber, a portable compact disc read-only memory (CD-ROM), an optical storage device, a magnetic storage device, or any suitable combination of the foregoing. In the text herein, the computer readable storage medium can be any tangible medium that includes or stores a program. The program may be used by an instruction execution system, apparatus or device or used in conjunction therewith.

The computer-readable signal medium may be included in a baseband or serve as a data signal propagated by part of a carrier, and it carries a computer-readable program code therein. Such propagated data signal may take many forms, including, but not limited to, electromagnetic signal, optical signal or any suitable combinations thereof. The computer-readable signal medium may further be any computer-readable medium besides the computer-readable storage medium, and the computer-readable medium may send, propagate or transmit a program for use by an instruction execution system, apparatus or device or a combination thereof.

The program codes included by the computer-readable medium may be transmitted with any suitable medium, including, but not limited to radio, electric wire, optical cable, RF or the like, or any suitable combination thereof.

Computer program code for carrying out operations disclosed herein may be written in one or more programming languages or any combination thereof. These programming languages include an object oriented programming language such as Java, Smalltalk, C++ or the like, and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Finally, it is appreciated that the above embodiments are only used to illustrate the technical solutions of the present disclosure, not to limit the present disclosure; although the present disclosure is described in detail with reference to the above embodiments, those having ordinary skill in the art should understand that they still can modify technical solutions recited in the aforesaid embodiments or equivalently replace partial technical features therein; these modifications or substitutions do not cause essence of corresponding technical solutions to depart from the spirit and scope of technical solutions of embodiments of the present disclosure.

What is claimed is:

1. A method of obtaining picture annotation data, wherein the method comprises:
obtaining a recognition result of a to-be-annotated picture;
displaying the to-be-annotated picture and the corresponding recognition result on an annotation interface;
using an annotator's selection of the recognition result in the annotation interface, to obtain annotation data of the to-be-annotated picture.

2. The method according to claim 1, wherein the obtaining a recognition result of a to-be-annotated picture comprises:
obtaining the recognition result of the to-be-annotated picture through machine learning.

3. The method according to claim 2, wherein the recognition result comprises: identification information and confidence parameters of one or more target objects corresponding to the to-be-annotated picture.

4. The method according to claim 3, wherein the displaying the to-be-annotated picture and a corresponding recognition result on an annotation interface comprises:
providing an information selection area, sequentially displaying the identification information of said one or more target objects in the information selection area according to magnitude of the confidence parameters, for selection by the annotator.

5. The method according to claim 4, wherein the displaying the to-be-annotated picture and a corresponding recognition result on an annotation interface further comprises:
while displaying the identification information of the target object, displaying one or more sample pictures corresponding to the target object for comparison and reference of the annotator with the to-be-annotated picture, wherein the sample picture is a picture obtained from a picture repository and matched with a search keyword, with the identification information of the target object as the search keyword.

6. The method according to claim 1, wherein the annotation interface further displays an information input area;
the method further comprises:
if the annotator does not select the recognition result in the annotation interface, regarding information input by the annotator in the information input area as the annotation data of the to-be-annotated picture.

7. The method according to claim 1, wherein the displaying the to-be-annotated picture and a corresponding recognition result on an annotation interface further comprises:
providing a button of replacing the to-be-annotated picture in the annotation interface,
upon clicking the button, replacing in the annotation interface with next to-be-annotated picture and corresponding recognition result.

8. The method according to claim 2, wherein the method further comprises:
regarding the to-be-annotated picture and the annotation data as sample data to train a recognition model of machine learning.

9. A device, wherein the device comprises:
one or more processors,
a storage for storing one or more programs,
the one or more programs, when executed by said one or more processors, enable said one or more processors to implement a method of obtaining picture annotation data, wherein the method comprises:
obtaining a recognition result of a to-be-annotated picture;
displaying the to-be-annotated picture and the corresponding recognition result on an annotation interface;
using an annotator's selection of the recognition result in the annotation interface, to obtain annotation data of the to-be-annotated picture.

10. The device according to claim 9, wherein the obtaining a recognition result of a to-be-annotated picture comprises:
obtaining the recognition result of the to-be-annotated picture through machine learning.

11. The device according to claim 10, wherein the recognition result comprises: identification information and confidence parameters of one or more target objects corresponding to the to-be-annotated picture.

12. The device according to claim 11, wherein the displaying the to-be-annotated picture and a corresponding recognition result on an annotation interface comprises:
providing an information selection area, sequentially displaying the identification information of said one or more target objects in the information selection area according to magnitude of the confidence parameters, for selection by the annotator.

13. The device according to claim 4, wherein the displaying the to-be-annotated picture and a corresponding recognition result on an annotation interface further comprises:
while displaying the identification information of the target object, displaying one or more sample pictures corresponding to the target object for comparison and reference of the annotator with the to-be-annotated picture, wherein the sample picture is a picture obtained from a picture repository and matched with a search keyword, with the identification information of the target object as the search keyword.

14. The device according to claim 9, wherein the annotation interface further displays an information input area;
the method further comprises:
if the annotator does not select the recognition result in the annotation interface, regarding information input by the annotator in the information input area as the annotation data of the to-be-annotated picture.

15. The device according to claim 9, wherein the displaying the to-be-annotated picture and a corresponding recognition result on an annotation interface further comprises:
providing a button of replacing the to-be-annotated picture in the annotation interface,
upon clicking the button, replacing in the annotation interface with next to-be-annotated picture and corresponding recognition result.

16. The device according to claim 10, wherein the method further comprises:
regarding the to-be-annotated picture and the annotation data as sample data to train a recognition model of machine learning.

17. A computer readable storage medium on which a computer program is stored, wherein the program, when executed by a processor, implements a method of obtaining picture annotation data, wherein the method comprises:
obtaining a recognition result of a to-be-annotated picture;
displaying the to-be-annotated picture and the corresponding recognition result on an annotation interface;
using an annotator's selection of the recognition result in the annotation interface, to obtain annotation data of the to-be-annotated picture.

18. The computer readable storage medium according to claim 17, wherein the obtaining a recognition result of a to-be-annotated picture comprises:
obtaining the recognition result of the to-be-annotated picture through machine learning.

19. The computer readable storage medium according to claim 18, wherein the recognition result comprises: identification information and confidence parameters of one or more target objects corresponding to the to-be-annotated picture.

20. The computer readable storage medium according to claim 19, wherein the displaying the to-be-annotated picture and a corresponding recognition result on an annotation interface comprises:
providing an information selection area, sequentially displaying the identification information of said one or more target objects in the information selection area according to magnitude of the confidence parameters, for selection by the annotator.
